(19) United States
(12) Patent Application Publication
(10) Pub. No.: US 2020/0259718 A1
(43) Pub. Date: Aug. 13, 2020

(54) MOBILE APPLICATION PERSONALITY CONFIGURATION

(71) Applicant: ARRIS Enterprises LLC, Suwanee, GA (US)

(72) Inventor: Navneeth N. Kannan, Doylestown, PA (US)

(21) Appl. No.: 16/531,197

(22) Filed: Aug. 5, 2019

Related U.S. Application Data
(60) Provisional application No. 62/803,720, filed on Feb. 11, 2019.

(51) Int. Cl. H04L 12/24; H04M 1/725; H04L 29/08

(52) U.S. Cl. CPC H04L 41/22; H04M 1/72583; H04L 67/125; H04M 1/72527

(57) ABSTRACT

A method and system of configuring a mobile application for managing and controlling customer premises equipment (CPE) and CPE are provided. Available configurable parameters of a mobile application are provided to multiple different service providers, selections of available configurable parameters are received from the multiple different service providers, and a set of unique mobile application personality configuration files for the mobile applications of the multiple different service providers are generated. The CPE may include a router that obtains a mobile application personality configuration file of a service provider and forwards it to a mobile device of a subscriber during an initial launch of the mobile application by the subscriber. The system includes a combination of the mobile application and the CPE.

### CROSS REFERENCE TO RELATED APPLICATIONS

This application claims the benefit under 35 USC §119(e) of U.S. Provisional Patent Application No. 62/803,720, filed Feb. 11, 2019.

### BACKGROUND

Mobile applications are becoming ubiquitous as a primary mode of interaction with various entities, and home consumer electronic devices are no exception. Gateways—for example, Data Over Cable Service Interface Specification (“DOCSIS”) gateways—traditionally were managed and controlled by the subscriber via a graphical user interface (“GUI”) screen, such as by logging on to a router from a personal computer (“PC”).

### SUMMARY

According to an embodiment, a method of configuring a mobile application for managing and controlling customer premises equipment (CPE) includes providing available configurable parameters of a mobile application to multiple different service providers, receiving selections of available configurable parameters from the multiple different service providers, and generating a unique mobile application personality configuration file for the mobile application for each of the multiple different service providers.

According to another embodiment, customer premises equipment (CPE) includes a router for communicating with equipment of a service provider and with a mobile electronic device of a subscriber of the service provider. The router is configured to obtain a mobile application personality configuration file of the service provider from the equipment of the service provider and to provide the mobile application personality configuration file to the mobile electronic device of the subscriber for use in configuring a mobile application for managing and controlling the CPE.

A system for configuring a mobile application for managing and controlling customer premises equipment (CPE) of multiple different service providers includes a mobile application with a default personality profile for download from an app store via mobile electronic devices of subscribers of the multiple different service providers and CPE having a router for communicating with a selected one of the multiple different service providers and with a mobile electronic device of the subscriber of the selected one of the multiple different service providers. The router is configured to automatically obtain a mobile application personality configuration file of the selected one of the multiple different service providers and to provide the mobile application personality configuration file to the mobile electronic device of the subscriber upon an initial launch of the mobile application by the subscriber for use in configuring the mobile application for managing and controlling the CPE.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a schematic view of a system for making a single mobile application available to subscribers of multiple service providers with the mobile application being capable of having multiple personalities with MSO specific configuration in accordance to an embodiment.

FIG. 2 is a view of a display screen of a smartphone of a subscriber of a service provider displaying a user interface provided by a configured mobile application in accordance to an embodiment.

FIG. 3 is a view of a display of a user interface provided by a customized mobile application.

FIG. 4 is a flowchart of a method of creating a configuration file for a mobile application in accordance to an embodiment.

FIG. 5 is a view of a display screen of a smartphone of a subscriber of a service provider displaying a user interface provided by a configured mobile application in accordance to an embodiment.

FIG. 6 is a diagram of a step of presenting configuration parameters to a service provider in accordance to an embodiment.

FIG. 7 is a diagram of steps for creating a personality profile in accordance to an embodiment.

FIG. 8 is a diagram of steps for run-time deployment of a personality profile and automatic App modification in accordance to an embodiment

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

In many cases, mobile applications may be able to replace traditional GUIs for managing and controlling home or other consumer electronic devices, customer-premises equipment (CPE), or any terminal and associated equipment typically located at a subscriber's premises and connected to a service provider's network or circuit at a demarcation point or gateway. A mobile application, also referred to as an app, is a type of application software designed to run on a mobile device, such as a smartphone, tablet computer, or like portable electronic device that typically communicates with networks and network devices via wireless communications.

In some embodiments the home consumer electronic device or CPE is a gateway which is a hardware device that acts as a “gate” between two networks, such as a home network and a service provider's network. An example of a service provider is a Multiple-System Operator (MSO), which may be an operator or service provider of multiple cable or direct-broadcast satellite television systems or the like. The gateway may be or include a router, firewall, server, or other device that enables traffic to flow in and out of a network.

Aspects of the present disclosure allow a single mobile application instance, that may be available for download by a consumer, subscriber, homeowner or the like from an App Store or the like, to take on a unique personality based on a separately obtained personality configuration file. Thus, the same mobile application may be downloaded and utilized by subscribers of many different service providers and thereafter be configured with configuration files of the service providers to reflect a distinct and desired personality of each particular service provider.

According to embodiments disclosed herein, a single generic mobile application stored in the App Store is adequate to cover the needs of all subscribers, regardless of the service provider to which a particular subscriber is associated. However, certain operators (i.e., service providers, such as MSOs) may desire some level of customization, including branding the mobile application to provide their subscribers with an experience that is reflective of their brand and interests in features that the operator desires their subscribers to have. Conventionally, this objective has been accomplished by creating multiple separate and distinct versions of a mobile application that is customized and branded as well as named differently and made available on an Application Store as separate mobile applications (i.e., a separate mobile application for each MSO or service provider).

While the above approach of creating completely separate mobile applications may provide a valid method, it is difficult, expensive, and time consuming when the number of such service operators is large, thereby requiring multiple versions of a mobile application to be separately created and managed and maintained in an Application Store. Multi-tenanted, cloud-based software-as-a-service (“SaaS”) type delivery is another option, but that requires significant infrastructure as well.

All the above described constraints call for another type of solution that may permit a mobile application to be branded and readily configurable without occurring the above referenced difficulties, time and expense. Accordingly, the present disclosure introduces the concept of a personality profile, applicable to a group of users that all belong to some common collection. Thus, according to some embodiments, a single mobile application may be stored in an App Store, and the mobile application is configured upon first launch by the subscriber, for instance based on information of the system in which the subscriber brings up and launches the application. Thus, as initially downloaded by a subscriber of a service provider, the mobile application is generic and configurable, and after it has been launched for a first time by the subscriber, becomes configured and branded as desired by the particular service provider of the subscriber.

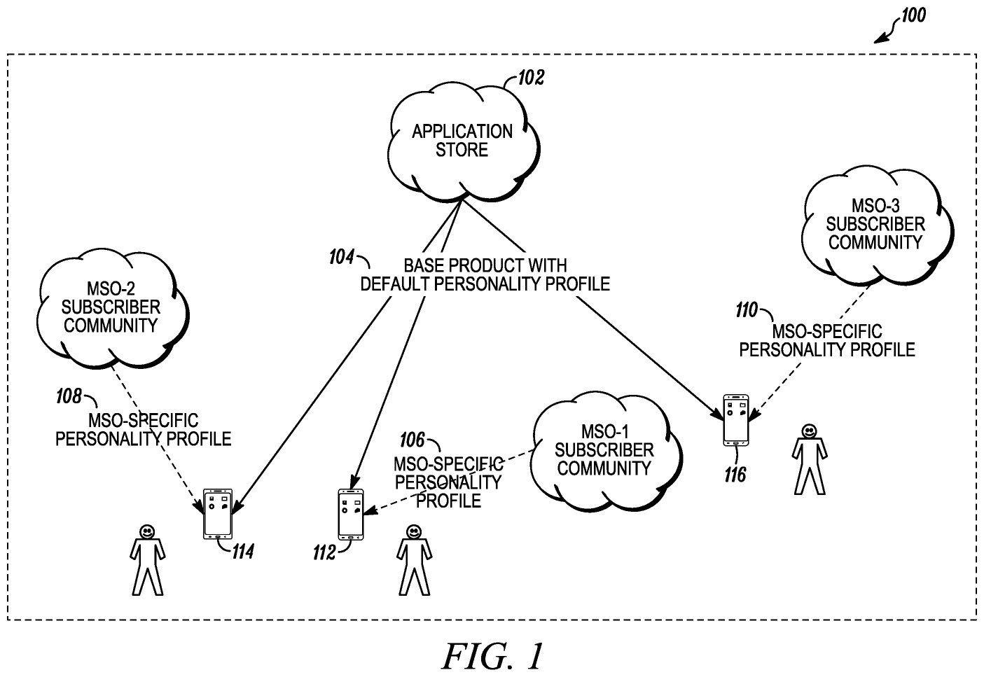

FIG. 1 discloses an example of an embodiment in which all subscribers that belong to a particular MSO (i.e., either MSO-1, MSO-2, or MSO-3 in the example provided by FIG. 1) will obtain a common user-interface (112 for MSO-1, 114 for MSO-2, or 116 for MSO-3) that is reflective of the desires of the specific MSO. However, the user-interface 112 may have branding and provide features that are different from that provided by the user interfaces 114 and 116 despite being a mobile application for the same or similar home consumer electronic device, such as a home gateway.

The system 100 of FIG. 1 provides a single mobile application capable of having multiple personalities with MSO configuration, in accordance with an embodiment. An aspect of the present disclosure introduces the concept of a “personality profile”. In one embodiment of the proposed solution, a single product (i.e., mobile application 104) is shown being provided and available for download by a subscriber via an Application Store 102. Here, it should be recognized that the same mobile application may be provided in different formats for use in different operating systems, for example, as an iOS app, an Android app, or the like but is still considered a single mobile application. The single mobile application (104) has a so-called default personality profile (i.e., it has yet to be configured with branding information, etc. as may be desired by a particular MSO).

When a subscriber of an MSO downloads the mobile application 104 and accesses it in the context of the subscription within his/her Service Provider (MSO), the application (upon initial launch) automatically retrieves or receives the MSO-Specific personality profile (106 for MSO-1, 108 for MSO-2, or 110 for MSO-3) and configures itself to present a user-interface (112 for MSO-1, 114 for MSO-2, or 116 for MSO-3) that is specific to the subscribers within that MSO community. For instance, the MSO specific configuration file may be delivered to the subscriber's gateway or like CPE, and the gateway or like CPE may deliver the MSO specific configuration file to the Mobile Application upon first launch so that the mobile application is able to be branded and configured as desired by the particular MSO or service provider. Each MSO or service provider may have a unique configuration file that is different from other MSOs and service providers (i.e., may provide unique branding, layout, color, appearance, features, etc.).

Examples of embodiments of systems and methods according to embodiments are provided below.

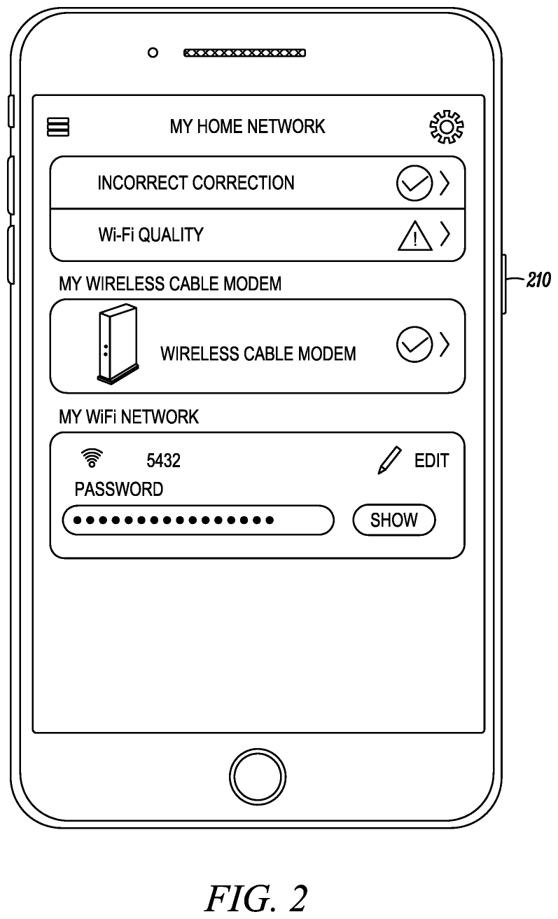

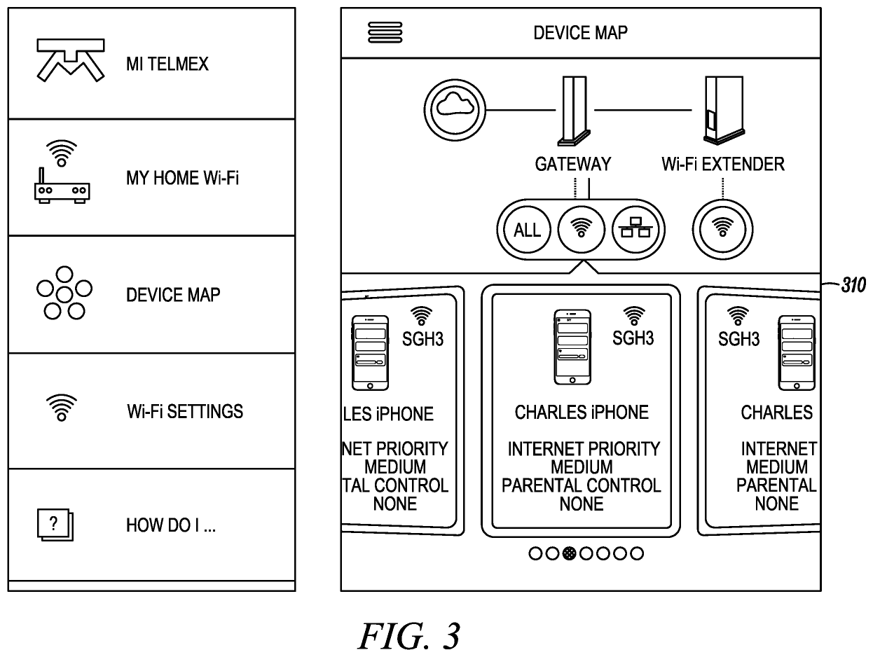

FIG. 2 and FIG. 3 illustrate the differences between configurability of a Personality Profile versus completely separate customization.

FIG. 2 depicts a smartphone (i.e., mobile device) of a subscriber of a service provider with an illustrative example of a configurable mobile application 210. “Configurability”, in an embodiment, refers to the adaptability of the mobile application to exhibit modified appearance and behavior, based on a bounded set of preferences, e.g., a set specified by the MSO. The configurability may include co-branding of MSO/service provider logos, inclusion/exclusion of features, modified verbiage, selection of themes, colors and appearance, inclusion of specific contact links such as URLs, and the like. However, the mobile application is still the result of a single mobile application uploaded to and made available for download by an application store, but dynamically gets configured to an MSO-specific profile upon syncing with the subscriber's gateway to receive the desired configuration profile.

For purposes of contrast, FIG. 3 depicts an illustrative example of a user interface provided by a customizable application 310 with customized features. The FIG. 2 and FIG. 3 embodiments are meant to differentiate the concept of configurability from customization. The significant difference is that customization of an app also invariably results in a separate mobile application needing to be posted (e.g., perhaps in the name of the MSO) in the applicable Application Store and required to be maintained along with other separate versions. An example of app customization is a complete re-creation of an MSO-specific application, e.g., with a much wider degree of freedom in the design of the user interface including navigation, features, reports, and the like. This is typically offered as a service offering and requires significant effort for each re-creation, resulting in delays, additional costs, and the like. A typical result of customization is a completely MSO-owned application that is separately uploaded to an Application Store. Accordingly, embodiments disclosed herein are directed to automatic configurability of a single mobile application having a default personality profile as initially downloaded which is thereafter configured upon first launch of the application. According to embodiments, separate mobile applications for each service provider is not required.

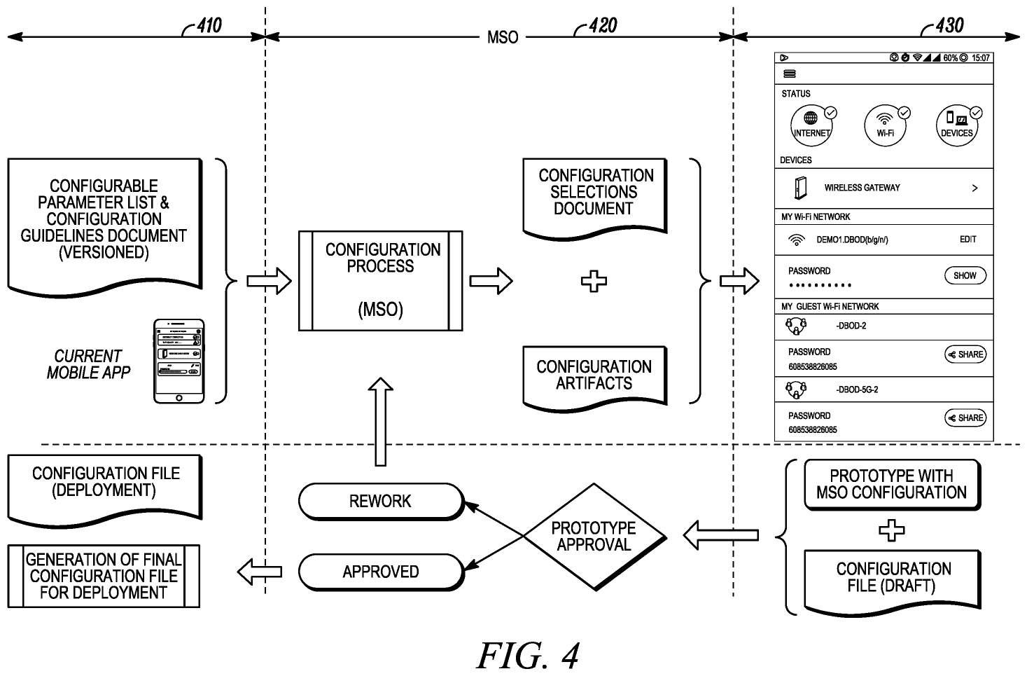

FIG. 4 discloses an embodiment of a process for creating a Personality Configuration File (such as MSO-specific Personality Profiles 106, 108 and 110 previously discussed with respect to FIG. 1). In the depicted embodiment provided by FIG. 4, process steps/elements 410 and 430 are under the control of and are performed by the mobile application provider, and process steps/elements 420 are under the control of and are performed by a service provider of a subscriber, such as an MSO. Here, the mobile application provider and the MSO are different entities. For instance, the mobile application provider may be the manufacturer of gateway devices offered for sale to the MSO or may be any other separate vendor of the MSO.

At the outset of the process of FIG. 4, there is a need for definitions for all configurable parameters, or elements that are part of the mobile application. In a specific example, this may be in the form of a list of options such as placement of an operator logo, color choices/layouts for the screens, choices in verbiage as well as the ability to specifically turn on/off certain features. Of course, other parameters and features may also be included.

Accordingly, groupings of configurable elements are identified that would help drive a personality profile. The following list provides a specific embodiment of elements that may constitute configurable parameters. Configurable elements can be broadly classified into the following categories: Color themes; Verbiage (e.g. “Resume” versus “Unpause”), as long as they are within the constraints; Feature On/Off: Based on liking; Order of lists/screens; and Branding Elements (Logos and such).

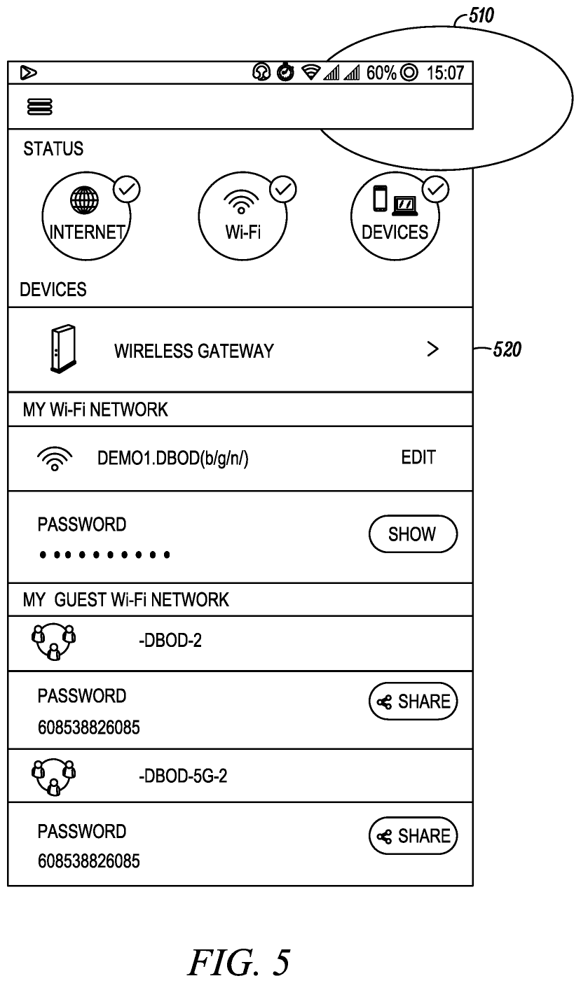

The goal is to provide a sufficient number of options for an MSO to create a unique personality profile by making choices with respect to various configuration elements. By way of example, and not by way of limitation, FIG. 5 shows some examples in an embodiment of a display produced by a Mobile Application. For example, an MSO logo can be placed at different places on the user interface display, such as illustrative location 510, based, e.g., on available screen real estate, with artwork to be provided by the MSO based on size constraints identified by the mobile application provider. According to one embodiment, the mobile application provider can provide a prototype of the resulting display in real-time or with delay to show how a logo may appear when displayed in different screen formats.

On certain screens or screen areas 520 of a configured user interface provided by the mobile application, color options may be provided, sets of themes may be provided, with the MSO selecting a color and theme from the choices provided by the mobile application provider. The language appearing on certain screen areas may be input by the MSO and certain features of the mobile application may be turned off or on by the MSO.

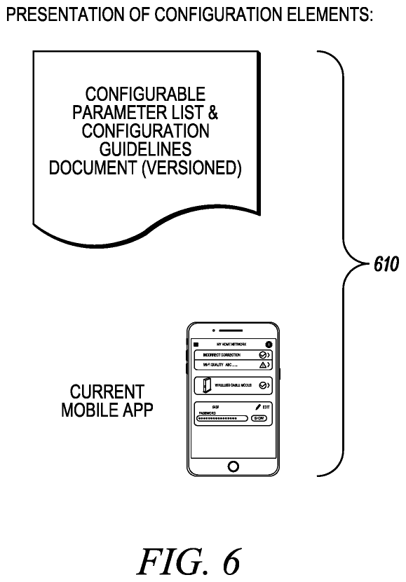

In an embodiment of the process shown in FIG. 4, a first step can include the presentation of the configuration elements, e.g., as depicted in FIG. 6 as an example. FIG. 6 corresponds to the process step performed by the mobile application provider in the upper left-hand side of FIG. 4. Thus, the first artifact that is required for creating a personality profile is to obtain a view of all the potential choices for the configurable elements 610. In a simplified embodiment, this may be achieved by providing a simple document that lists all the configurable elements, along with the choices as well as constraints. In a further example of an embodiment, the configurable elements may be presented in the form an “Application Wizard” that would be presented as a “What you see is what you get” view, with options for changing the configurable elements through pull-down menus, uploading graphic assets and artifacts for logos, trying out different color combinations and such. The advantage of this embodiment is that the user is able to create and visualize a personality profile in real-time or with limited delay before finalization and deployment.

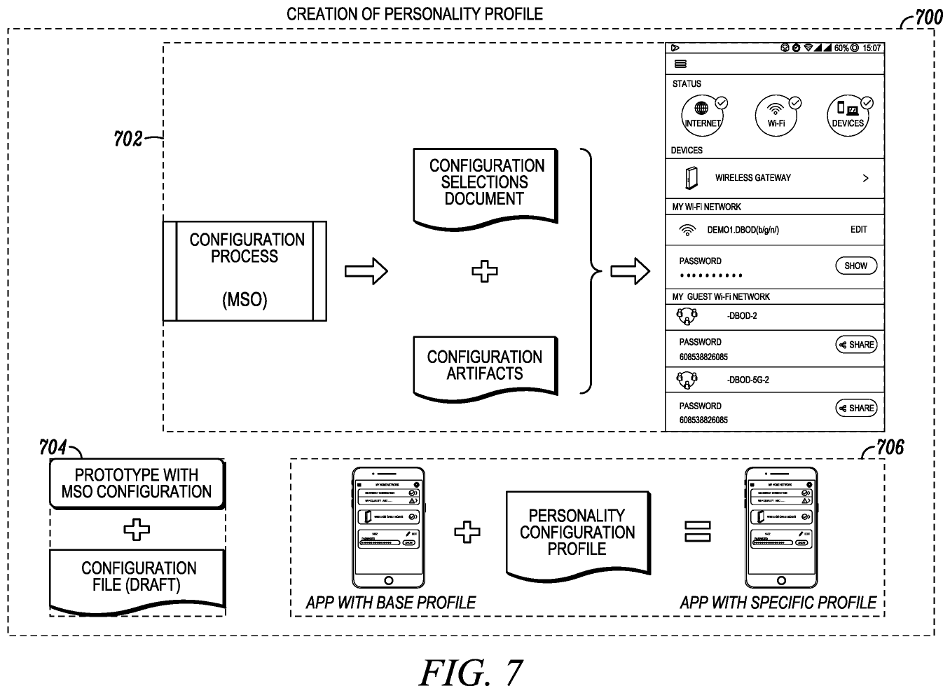

An example of a system 700 for creation of the personality profile is depicted in FIG. 7. The step 702 of system 700 corresponds to the process step of the MSO in the upper portion of FIG. 4 and the process step of the mobile application provider in the upper-right portion of FIG. 4 and the step 704 corresponds to the process step of the mobile application provider in the lower-right portion of FIG. 4. As discussed above, the ‘Configuration Process’ can be either manual or using a wizard, but with the ultimate output being a “Configuration file”. In step 702, the MSO makes selections and uploads images of logos, wording, and the like. From this information, the mobile application provider creates a prototype of the MSO-specific user interface. In step 704, the mobile application provider may provide a prototype of the MSO-specific user interface and may create a Mobile Application Personality Configuration File (MAP-CONF file) for the particular MSO which captures the MSO choices for the various configurations. Thus, in step 706, the user interface provided with the default personality profile is shown (i.e., “App with Base profile”) and in combination with the MAP-CONF file produces the branded and configured user interface generated with the mobile application configured with the MAP-CONF file of the MSO (i.e., “App with Specific profile”).

Referring to the lower part of FIG. 4, the MSO can approve the prototype or rework the mobile application and repeat the above steps. After final approval is provided by the MSO, the MAP-CONF file for the MSO is groomed for final data correctness, finalized and deployed (see lower-left of FIG. 4). Accordingly, in use, the original downloaded default version of the mobile application is self-modified on initial launch based upon the MAP-CONF file created by the above referenced systems, processes, and methods or the like.

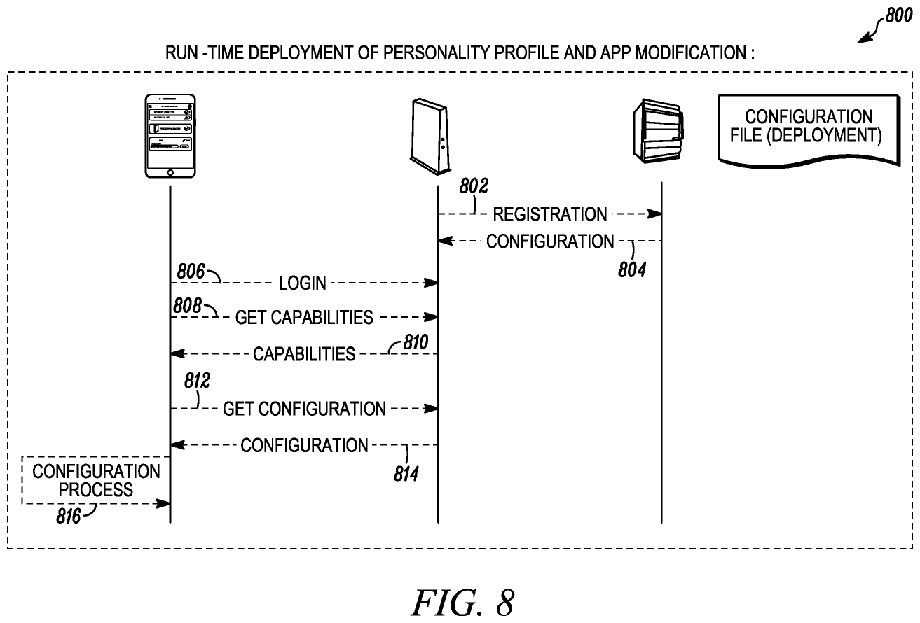

According to an embodiment, a system 800 for run-time deployment of the personality profile and app modification is depicted in FIG. 8. This involves ensuring that the correct personality profile (configuration file) is picked up by the mobile application downloaded by a subscriber of a specific service provider (MSO), so that the mobile application automatically self-adjusts to present a desired (branded and configured) user interface of the mobile application to the subscriber based on the personality profile of the subscriber's service provider.

In a specific example of an embodiment, the Personality Profile data of the MSO is stored in a cable modem termination system (CMTS) or other headend equipment, server, or the like by the service provider or a vendor thereof. A CMTS is a piece of equipment, typically located in a cable company's headend or hubsite, which is used to provide high speed data services, such as cable Internet or Voice over Internet Protocol, to cable subscribers. In step 802, a gateway, router, or like CPE installed on the consumer premise or the like registers with the CMTS or like headend equipment as a result of initial installation. Following registration with the CMTS, the CMTS forwards the Personality Profile data to or enables the Personality Profile data to be obtained by the gateway to provision the gateway with the configuration file (see step 804). This may occur as a result of a direct file transfer or may be achieved with a link to a provider-hosted server which holds personality profiles of different MSOs. Thus, the gateway is provided with information concerning the specific service provider network to which the gateway is connected (i.e., the gateway or router knows where it is located and to which network and service provider it is interconnected).

The subscriber of the newly installed gateway then can download the mobile application (having a default personality profile) from an App Store or the like and then can then launch the mobile application (such as with login information provided by the service provider) in step 806. The mobile application on the subscriber's smartphone or like device communicates with the gateway or router via wireless communications at the customer premises and requests the capabilities of the gateway in step 808 from the gateway and then receives the requested capabilities from the gateway in step 810. The capabilities relate to the capabilities of the gateway and with respect to features that have either been turned-on or turned-off by the service provider. The mobile application on the subscriber's smartphone or like device may also request the configuration file (personality profile) from the gateway in step 812 and then receives the requested configuration file from the gateway in step 814. Thereafter, the mobile application on the subscriber's smartphone is automatically configured in step 816 so that the user interface presented to the subscriber has the personality profile corresponding to their specific service provider (i.e., logos, artwork, language, colors, themes, screens, capabilities, etc.). Accordingly, this is the user interface or display presented to the subscriber from the mobile application and this information is cached for ongoing use. Of course, a different subscriber of a different service provider having an identical gateway or CPE would download the same mobile application; however, as a result of configuration with the personality profile of their specific service provider, may be presented with a completely different user interface or display (i.e., different logos, artwork, language, colors, themes, screens, capabilities, etc.).

In an embodiment, implementations of the subject matter and the functional operations described in this specification can be provided in digital electronic circuitry, or in computer software, firmware, or hardware, including the structures disclosed in this specification and their structural equivalents, or in combinations of one or more of them. Some embodiments of the subject matter of this disclosure, and components thereof, can be realized by software instructions that upon execution cause one or more processing devices to carry out processes and functions described above. Further embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

In some embodiments, the processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

In some embodiments, an apparatus or device embodying the invention may be in the form of a gateway, an access point, a set-top box or other standalone device, or may be incorporated in a television or other content playing apparatus, or other device, and the scope of the present invention is not intended to be limited with respect to such forms.

Components of some embodiments may be implemented as Integrated Circuits (IC), Application-Specific Integrated Circuits (ASIC), or Large-Scale Integrated circuits (LSI), system LSI, super LSI, or ultra LSI components. Each of the processing units can be many single-function components, or can be one component integrated using the technologies described above. Components may also be implemented as a specifically programmed general purpose processor, CPU, a specialized microprocessor such as Digital Signal Processor that can be directed by program instructions, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

It is also contemplated that implementations and components of embodiments can be done with any newly arising technology that may replace any of the above implementation technologies.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, where operations are depicted in the drawings in a particular order, this should not be understood as requiring that such operations be performed in the particular order shown or in sequential order unless otherwise noted, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the disclosed technique may be implemented using program instructions, operating system (such as a driver for interface circuit) or in firmware in an interface circuit. Alternatively or additionally, at least some of the operations in the disclosed technique may be implemented in a physical layer, such as hardware in an interface circuit.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

Having described the invention in detail, it will be understood that such detail need not be strictly adhered to, but that additional changes and modifications may suggest themselves to one skilled in the art. The invention is defined solely by the appended claims.

I claim:

1. A method of configuring a mobile application for managing and controlling customer premises equipment (CPE), comprising:
providing available configurable parameters of a mobile application to multiple different service providers which provide services via the CPE;
receiving selections of available configurable parameters from the multiple different service providers; and
generating a unique mobile application personality configuration file for the mobile application for each of the multiple different service providers.

2. The method according to claim 1, further comprising the step of receiving artifacts from the multiple different service providers.

3. The method according to claim 2, wherein the artifacts include at least one of a branding image, a logo, and verbiage.

4. The method according to claim 1, wherein the available configurable parameters include at least one of user interface logo placement, display appearance, display theme, screen display order, display colors, and verbiage.

5. The method according to claim 1, wherein the available configurable parameters include a turning-on or turning-off selected CPE capabilities or features.

6. The method according to claim 1, further comprising the step of providing the mobile application with a default personality profile for download by subscribers of the multiple different service providers.

7. The method according to claim 6, wherein the mobile application with the default personality profile is downloadable to a mobile electronic device of a subscriber by download from an app store.

8. The method according to claim 6, further comprising the step of configuring the mobile application upon initial launch by a subscriber of a service provider to obtain the mobile application personality configuration file of the subscriber's service provider.

9. The method according to claim 8, wherein, upon initial launch, the mobile application is configured to obtain the mobile application personality configuration file from communications with the subscriber's CPE.

10. The method according to claim 8, further comprising the step of configuring the mobile application to utilize the mobile application personality configuration file of the subscriber's service provider obtained during the initial launch to modify a user interface display generated by the mobile application.

11. The method according to claim 1, wherein the CPE is a gateway.

12. A customer premises equipment (CPE) device comprising a router for communicating with equipment of a service provider and with a mobile electronic device of a subscriber of the service provider, the router being configured to obtain a mobile application personality configuration file of the service provider from the equipment of the service provider and to provide the mobile application personality configuration file to the mobile electronic device of the subscriber for use in configuring a mobile application for managing and controlling the CPE.

13. The CPE device according to claim 12, wherein the CPE device is a gateway or a network device of a wireless local area network.

14. The CPE device according to claim 12, wherein the service provider is a Multiple-System Operator (MSO) and the equipment of a service provider is at least one of headend equipment, a server, and a cable modem termination system (CMTS).

15. The CPE device according to claim 12, wherein the mobile application personality configuration file contains at least one of a branding image, logo, user interface logo placement, display design, display theme, screen display order, display colors, and verbiage selected by the service provider.

16. A system for configuring a mobile application for managing and controlling customer premises equipment (CPE) of multiple different service providers, comprising:
a mobile application with a default personality profile for download from an app store via mobile electronic devices of subscribers of the multiple different service providers; and
customer premises equipment (CPE) having a router for communicating with a selected one of the multiple different service providers and with a mobile electronic device of a subscriber of the selected one of the multiple different service providers;
the router being configured to automatically obtain a mobile application personality configuration file of the selected one of the multiple different service providers and to provide the mobile application personality configuration file to the mobile electronic device of the subscriber upon an initial launch of the mobile application for use in configuring the mobile application for managing and controlling the CPE.

17. The system according to claim 16, wherein the mobile application personality configuration file is produced by providing available configurable parameters of the mobile application to multiple different service providers, receiving selections of available configurable parameters from the multiple different service providers, and generating a unique mobile application personality configuration file for the mobile application for each of the multiple different service providers.

18. The system according to claim 16, wherein the mobile application personality configuration file includes data of at least one of a user interface branding image, logo, logo placement, display design, display theme, screen display order, display colors, and verbiage.

19. The system according to claim 16, wherein the mobile application is configured such that, upon initial launch by a subscriber of the selected one of the multiple service providers, the mobile application causes the mobile application personality configuration file to be obtained from the CPE.

20. The system according to claim 19, wherein the mobile application is configured to utilize the mobile application personality configuration file obtained during the initial launch to modify a user interface display generated by the mobile application.
